(19) United States
(12) Patent Application Publication
(10) Pub. No.: US 2009/0025052 A1
(43) Pub. Date: Jan. 22, 2009

(54) Method and Apparatus for Controlling the Bandwidth of SDV Programming Supplied to an Edge Device in a n SDV System

(75) Inventors: John Schlack, Quakertown, PA (US); Fred J. Allegrezza, Hatfield, PA (US); Ludwig Cliff Lewis, Jamison, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/779,297

(22) Filed: Jul. 18, 2007

(51) Int. Cl. H04N 7/173

(52) U.S. Cl. 725/116

(57) ABSTRACT

A switched digital video (SDV) system is provided that includes an SDV manager for coordinating SDV sessions requested by subscriber terminals associated with a service group. An input is provided for receiving content to be broadcast during the SDV sessions. At least one edge device is provided for receiving transport streams that include SDV programming provided by the input and for transmitting each transport stream over an access network to at least one of the subscriber terminals on one of a plurality of SDV channels. The SDV manager is configured to (i) monitor bandwidth used by the edge device to provide the SDV programming to the service group and (ii) cause a bit rate of at least one SDV program supplied to the edge device to be adjusted based on the monitored bandwidth usage.

### FIELD OF THE INVENTION

The present invention relates generally to a switched digital video system for distributing content to a subscriber over a system such as a satellite or cable television system, and more particularly to a switched digital video system that includes multiple edge device resources supplying content to the subscriber, which resources need to be reallocated when their available bandwidth becomes limited.

### BACKGROUND OF THE INVENTION

Switched digital video (SDV) refers to an arrangement in which broadcast channels are only switched onto the network when they are requested by one or more subscribers, thereby allowing system operators to save bandwidth over their distribution network. In conventional cable or satellite broadcast systems, every broadcast channel is always available to all authorized subscribers. In contrast, a switched digital video channel is only available when requested by one or more authorized subscribers. Also, unlike video on-demand, which switches a singlecast interactive program to a user, switched digital video switches broadcast streams, making each stream available to one or more subscribers who simply join the broadcast stream just as they would with normal broadcast services. That is, once a switched service is streamed to a subscriber, subsequent subscribers associated with the same service group as the first subscriber can tune to the same broadcast stream. The switched digital video will often share the same resource managers and underlying resources with other on demand services.

As noted, switched digital video is largely a tool to save bandwidth. From the subscriber perspective, he or she still receives the same broadcast video service when using a switched broadcast technique; ideally the user is not able to discern that the stream was switched at all. If each one of the digital broadcast channels is being watched by subscribers in the same service group, the switched digital video approach does not yield any bandwidth savings. However, a more likely situation statistically is that only a certain number of the digital broadcast channels are being watched by subscribers in the same service group at any given time. Those channels not requested by a subscriber need not be broadcast, thereby saving bandwidth.

One way to support switched digital video is to utilize the Session Manager to manage broadcast sessions. For each channel change, the subscriber will set up a broadcast session with the Session Manager, which will determine if the requested channel is already being sent to the corresponding service group that the subscriber belongs to. The subscriber will be assigned to join the existing broadcast session if the requested channel is available at the service group or assigned to a new broadcast session if the requested channel is not available at the service group. The Session Manager will negotiate with the edge devices to allocate resources required for the session. The edge device (e.g., a digital modulator such as a QAM modulator) needs to dynamically retrieve the MPEG single program transport stream that carries the requested broadcast program (likely via IP multicast) and generate the MPEG multiple program transport stream. As part of the session setup response message, the video tuning parameters such as frequency and MPEG program number are sent back to the subscriber to access the requested broadcast channel.

When a viewer begins watching a SDV channel, the bandwidth of the QAM modulator distributing the SDV channel is reduced. That is, each time a SDV channel is bound to a QAM modulator its remaining available bandwidth decreases. Since bandwidth resources are limited, it is possible for a blocking situation to arise in which a new SDV channel cannot be bound to a QAM modulator due to lack of bandwidth. This is especially true if viewers frequently “channel surf” through “long tail” (i.e., infrequently viewed) content or turn off their television while leaving on their set top terminal so that it continues to receive a SDV channel. The increasing usage of DVRs to record programming may also adversely impact the available bandwidth if less popular programming is recorded.

Statistical multiplexers are sometimes used to reduce the likelihood of a blocking situation arising. A statistical multiplexer attempts to estimate the complexity of the video streams on the SDV channels and allocates bandwidth so as to provide an approximately constant level of video quality across all of the multiplexed streams. In particular, a statistical multiplexer takes multiple MPEG2 streams (e.g. 14 variable bit rate streams each with a maximum of 8 Mb/s and an average of 4 Mb/s) and adjusts the streams (still using variable bit rates) to add up to a total fixed bandwidth (e.g. 38.8 Mb/s for a QAM256). However, the complexity and cost involved with statistical multiplexing can be considerable.

### BRIEF DESCRIPTION OF THE DRAWINGS

FIG. 1 shows one example of a system architecture for delivering switched digital video content to a subscriber.

FIG. 2 shows one example of the headend depicted in FIG. 1.

FIGS. 3 and 4 shows a simplified version of the system architecture of FIG. 1 for the purpose of illustrating techniques for adjusting the bandwidth of SDV programming.

FIGS. 5a and 5b show the allocation of bandwidth among SDV channels before and after replacing a high bit rate channel with a lower bit rate channel when multiple copies of each programming stream are available.

FIG. 6 shows one alternative example of the headend depicted in FIG. 2 in which a transcoder is employed

FIG. 7 is a flowchart showing one example of a method for managing bandwidth in an SDV system.

### DETAILED DESCRIPTION

As detailed below, instead of using a statistical multiplexer to dynamically reduce the bandwidth of SDV channels by adjusting the encoding bit rate when the bandwidth becomes limited, a feedback-controlled rate clamp may be used to adjust the bandwidth. In the examples presented below, the feedback is provided by a Session or SDV Manager. More generally, however, the feedback may be provided in any appropriate manner by any suitable arrangement.

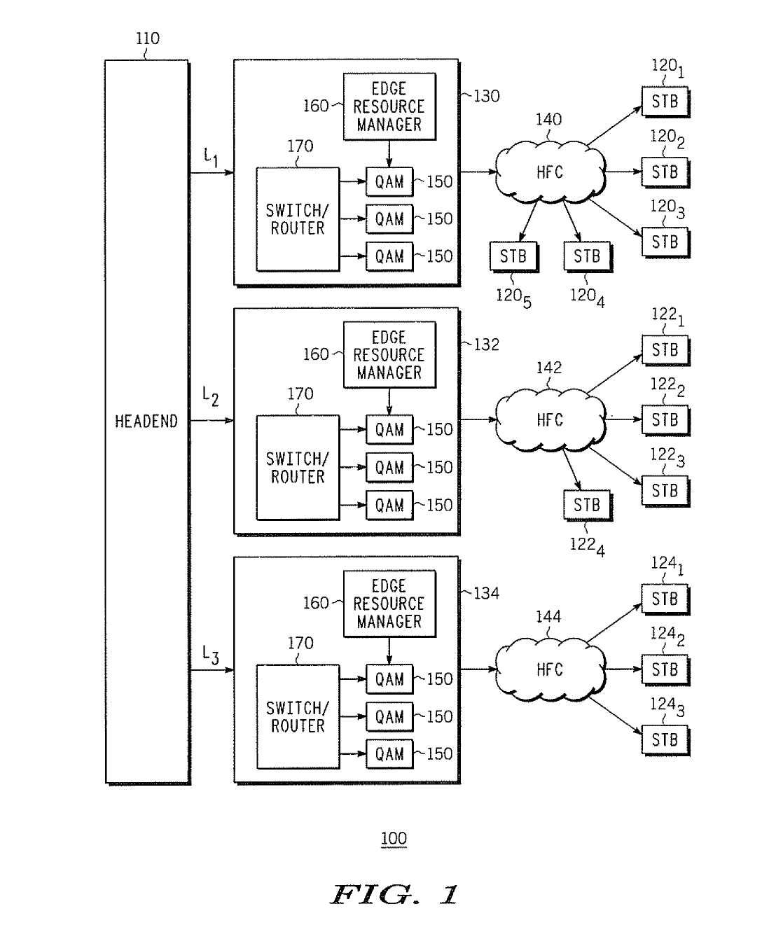

FIG. 1 is a system architecture 100 for delivering switched digital channels to a subscriber during a switched digital video (SDV) session. The SDV session is implemented through a service offering in which application level data generated by a set-top terminal initiates a SDV session request and an SDV manager routes data in accordance with the request to provision the service. Among other components, system architecture 100 comprises a content source such as a headend 110 that is connected to multiple intermediate entities such as hubs 120₁, 120₂, and 120₃. The headend 110 communicates with a switch or router 170 in hubs 130, 132 and 134 over links L1, L2 and L3, respectively. The headend 110 and hubs 120₁, 120₂ and 120₃ may communicate over a packet-switched network such as a cable data network, passive optical network (PON) or the like using, for example, IP multicast addressing.

Some or even all of the hubs are connected to multiple users, typically via distribution networks such as local cable access networks (e.g., HFC networks). For simplicity of explanation only, each hub is shown as being connected to a distinct HFC network, which in turn communicate with end user equipment as illustrated. In particular hubs 130, 132 and 134 in FIG. 1 communicate with access networks 140, 142 and 144, respectively. Each access network 140, 142 and 144 in turn communicates with multiple end user devices such as set top or subscriber terminals. In the example of FIG. 1, access network 140 communicates with set top terminals 120₁, 120₂, 120₃, 120₄ and 120₅, access network 142 communicates with set top terminals 122₁, 122₂, 122₃ and 124₄, and access network 144 communicates with set top terminals 124₁, 124₂ and 124₃.

In addition to the switch or router 170, each hub can include an array of radio frequency transmitter edge devices such as edge QAM modulators 150. The number of edge devices 150 in each hub may vary as needs dictate. As used herein, the term “QAM” refers to modulation schemes used for sending signals over cable access networks. Such modulation schemes might use any constellation level (e.g. QAM-16, QAM-64, QAM-256 etc.) depending on the details of a cable access network. A QAM may also refer to a physical channel modulated according to such schemes. Typically, a single QAM modulator can output a multiplex of ten or twelve programs, although the actual number will be dictated by a number of factors, including the communication standard that is employed. The edge QAM modulators usually are adapted to: (i) receive Ethernet frames that encapsulate the transport packets, (ii) de-capsulate these frames and remove network jitter, and (iii) transmit radio frequency signals representative of the transport stream packets to end users, over the HFC network. Each transport stream is mapped to a downstream QAM channel. Each QAM channel has a carrier frequency that differs from the carrier frequency of the other channels. The transport streams are mapped according to a channel plan designed by the MSO that operates the network.

Each hub 130, 132 and 134 also includes an edge resource manager 160 for allocating and managing the resources of the edge devices 150. The edge resource manager 160 communicates with and receives instructions from the session manager located in the headend 110.

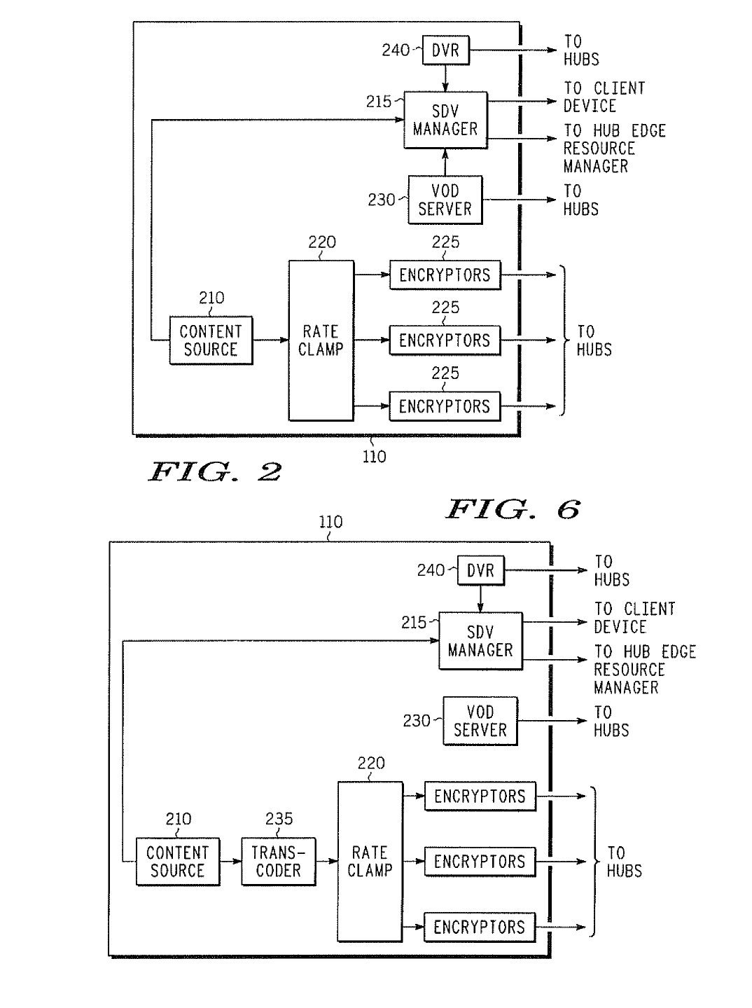

FIG. 2 shows one example of headend 110. The headend 110 includes a broadcast content source 210, which may include, by way of example, satellite receivers, off-air receivers and/or content storage devices such as servers. A SDV manager 215 is used to determine which SDV transport streams are being transmitted at any time and for directing the set top terminals to the appropriate stream. The SDV manager 215 also keeps track of which subscribers are watching which channels and it communicates with the edge resource managers 160 in the hubs so that the content can be switched on and off under the control of the SDV manager 215. In addition, all subscriber requests for a switched digital channel go through the SDV manager 215. The switched digital channels are forwarded to a rate clamp 220 and one or more encryptors 225 using, for example, IP multicast addressing. The content is then encrypted by the encryptors 225 and transmitted to the appropriate hub or hubs. Typically, standard definition (SD) channels are currently rate clamped to 3.75 Mbps while high definition channels are currently rate clamped to between about 12 Mbps and 15 Mbps. The encryptors 225 encrypt the digitally encoded content, often under the control of a conditional access system (not shown).

Headend 110 may also include a network DVR 240. The network DVR 240 stores content that can be transmitted to set top terminal via a hub and access network in response to a user request to play a program stored on the DVR 240. Other user input requests are also serviced by network DVR 240, including, for example, requests to accelerate the playing of a program in the forward direction (e.g., cueing) and in the reverse direction (e.g., reviewing). The content is stored by the network DVR 240 upon a user request. The content may be provided to the network DVR 240 from any available content source, including, for example, content source 210.

It should be noted that in some cases the functionality of some or all of the SDV manager 215 may be transferred to each of the hubs 130, 132 and 134. For example, as described below, the monitoring of network bandwidth and/or the control of the bit rate in response thereto, may be performed at the hubs.

Headend 110 may also include a variety of other components for offering additional services. For example, in FIG. 2 a video on demand (VOD) server 230 is shown for storing programs or other content for distribution to subscribers on an on-demand basis. Although not shown, one of ordinary skill in the art would recognize that other components and arrangements for achieving the various functionalities of headend 110 are possible. For example, the head-end 110 may comprise typical head-end components and services including a billing module, an advertising insertion module, a subscriber management system (SMS), a conditional access system and a LAN(s) for placing the various components in data communication with one another. It will also be appreciated that the head-end configuration depicted in FIG. 2 is a high-level, conceptual architecture and that each network may have multiple head-ends deployed using different architectures.

When a viewer selects an SDV channel using a subscriber terminal such as a set top terminal, the SDV system actively switches the channel onto one of the QAMs that serves that particular set top terminal. The set top terminals are generally arranged into service groups and each of the service groups is assigned to, and serviced by, one or more QAM modulators. For example, in the arrangement depicted in FIG. 1 set top terminals 120₁, 120₂, 120₃, 120₄ and 120₅ are assigned to QAM modulators 150 located at hub 130, set top terminals 122₁, 122₂, 122₃ and 122₄ are assigned to QAM modulators 150 located at hub 132, and set top terminals 124₁, 124₂ and 124₃ are assigned to QAM modulators 150 located at hub 134. Typically, four (4) or eight (8) QAM modulators are deployed per service group to carry the SDV channels. SDV service groups currently include from about 500 to 1000 set top terminals. Depending on the system topology, there may or may not be a one-to-one correspondence between the hubs and the service groups. For instance, it is typically the case that each hub serves multiple service groups.

As previously mentioned, situations can arrive when the bandwidth of the QAM modulator or modulators assigned to a service group becomes sufficiently limited so that a blocking situation may arise, thereby preventing any additional SDV channels from being supplied to that service group. This problem can be avoided by rate clamping the SDV channels provided to a service group when a bandwidth limiting situation arises. The SDV manager or other suitable entity can be used to determine when such a situation occurs or may soon occur by tracking or monitoring the bandwidth usage of each service group. For example, in the headend depicted in FIGS. 1 and 2, SDV manager 215 can receive bandwidth utilization information directly from the rate clamp 220. Alternatively, in some cases the SDV manager can monitor the QAM modulators 150 and/or set top terminals so that is knows which SDV channels are currently being utilized and when new SDV channels are requested. The SDV manager 215 can also direct the rate clamp 220 to adjust the bit rate as necessary based on the bandwidth information it obtains from the QAM modulators or the set top terminals. It should be noted that unlike a statistical multiplexer, a rate clamp takes a single stream with a constant or variable bit rate and adjusts the stream to a constant bit rate (e.g., a constant bit rate of 3.75 Mb/s).

In some cases the SDV manager 215 itself can select the programming stream(s) that is to be rate clamped. This selection can be made based on the nature of the content that is being presented. For example, news programs, cartoons and the like are typically low bandwidth programs that do not need to be encoded at the full or maximum rate. In addition to, or instead of, using generalities about the type of content when selecting an appropriate bit rate reduction for a program, the SVD manager or other entity can make this selection on a program by program basis, using, for example, information available in the electronic program guide. Alternatively, the SDV manager 215 can allow the rate clamp 220 to determine which programming streams are to be reduced in bandwidth.

If the selection is based on the nature of the content, the type of content embodied in any program stream can be readily identified by any appropriate means. For example, different types of content can be identified using a program schedule imported from a metadata source, such as Tribune TV Data (http://www.tvdata.com/ipgdata.html), or from an electronic program guide (EPG) such as TV Guide.

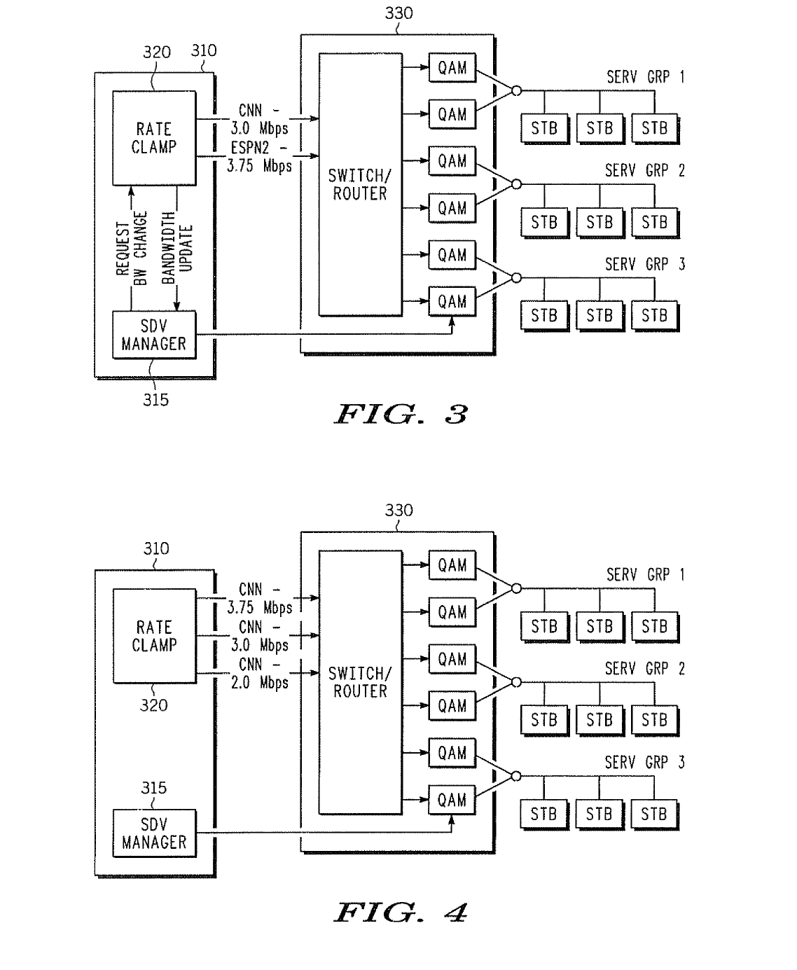

One technique for adjusting the bandwidth is depicted in connection with FIG. 3, which shows a simplified version of the system architecture of FIG. 1 with only a single hub 330 illustrated. For simplicity only those entities necessary for the present discussion are shown. In particular, only the SDV manager 315 and rate clamp 320 are shown in headend 310. Hub 330 includes six QAM modulators that provide programming to three service groups. A pair of QAM modulators is dedicated to each service group. In this example the SDV manager 315 directs the rate clamp 320 to reduce the bandwidth of a news source (CNN in this example) from 3.75 to 3.0 Mbps. If the bandwidth of several such channels are reduced, sufficient bandwidth can be recovered to support additional SDV channels. Of course, when the bandwidth is reduced in this manner all the service groups experience a reduction in the bandwidth of CNN.

Instead of conserving bandwidth by rate clamping a single programming stream that is associated with a single SDV channel, multiple copies of each programming stream may be provided, each of which are clamped to different bit rates. FIG. 4 shows an example of this approach. In FIGS. 3 and 4 like elements are denoted by like reference numbers. In this example three copies of a news source (CNN) programming stream are provided by the rate clamp to the hubs. Each copy is encoded at a different bit rate (e.g., 3.75, 3.0 and 2.0 Mbps). The SDV manager will normally bind the highest bit rate (i.e., highest video quality) stream to the appropriate QAM modulator(s) serving the service group or groups requesting the programming stream on a particular SDV channel. However, as the available QAM modulator bandwidth is reduced, the SDV manager may begin replacing the higher bit rate stream that is sent to the QAM modulator with a lower bit rate stream to prevent a blocking condition from occurring. That is, when bandwidth is limited the SDV manager switches the copy of the programming stream that is bound to the QAM modulator with a lower bit rate copy of the same programming stream. For example, in the present case the SDV manager can replace the CNN programming stream rate clamped at 3.75 Mbps with a CNN programming stream rate clamped at 3.0 or even 2.0 Mbps.

One advantage arising from the use of multiple copies of each programming stream clamped at different bit rates is that a low bandwidth situation impacting one service group does not need to affect all service groups. That is, a low bit rate version of a program stream can be provided to one service group when bandwidth to that service group becomes limited, while a higher bit rate version of the same program stream is being provided to another service group that has more available bandwidth. One drawback to this approach is that it requires additional bandwidth between the headend and the edge devices to support the multiple copies of each transport stream, but this is actually a relatively small cost both because many of these channels are sent at a reduced bit rate and because adding bandwidth between the headend and the hubs is relatively easy and cheap since it is packet—(e.g., IP) based.

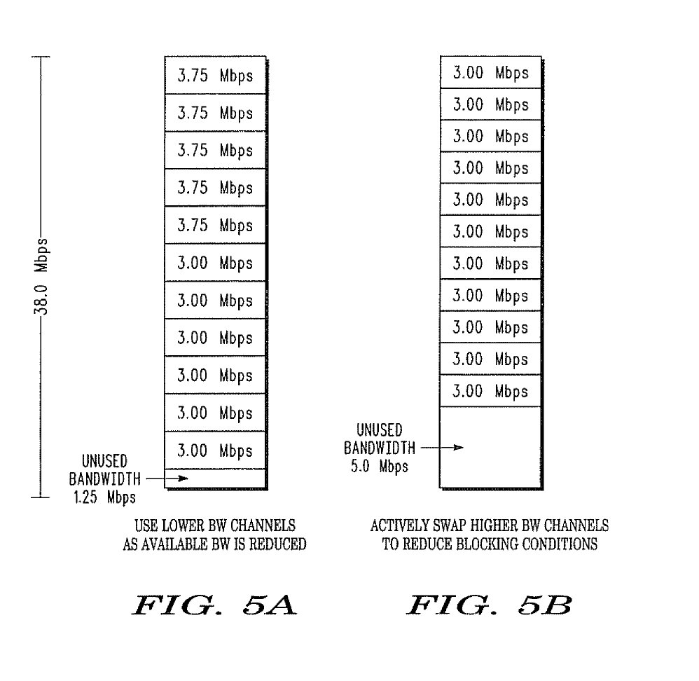

FIGS. 5a and 5b show an example of how the SDV manager can allocate bandwidth to a single edge device when multiple copies of each programming stream are available. The total bit rate that can be supported by the edge device in this example is 38.8 Mbps. In FIG. 5a the first five SDV channels are bound at a bit rate of 3.75 Mbps. At this point 50% of the available bandwidth has been utilized. Based on this degree of utilization, the SDV manager will rate clamp additional channels that are to be bound to the edge device at a bit rate of 3.0 Mbps. This allows 11 SDV channels to be bound to the edge device instead of 10 3.75 Mbps channels. When all the bandwidth is exhausted, the SDV manager actively swaps out 3.75 Mbps channels to make room for an additional SDV channel. FIG. 5b shows the bit rate allocation among the various channels after all the 3.75 Mbps channels have been replaced with 3.00 Mbps channels. The SDV manager may swap a lower bit rate program for a higher bit rate program during a commercial or other break in programming to minimize the impact of any artifacts on viewers. Using the 3.0 Mbps version of the SDV channels in this example instead of the 3.75 Mbps version increases the number of SDV channels that can be supported by 20%. In particular, 12 SDV channels can be supported at a bit rate of 3.0 Mbps, in comparison to 10 SDV channels that can be supported at a bit rate of 3.75 Mbps for a 38.8 Mbps QAM modulator. Of course, as subscribers terminate their SDV session the rate clamp can begin to replace lower bit rate programs with higher bit rate programs.

FIG. 6 shows one alternative example of the headend depicted in FIG. 2 in which a transcoder 235 is employed between the content source 210 and the rate clamp 220. The transcoder 235 can be used, for example, when both MPEG-2 and MPEG-4 transport streams are available. The transcoder 235 can be used to save bandwidth by converting an MPEG-2 stream into an MPEG-4 stream, which requires only about one-half the bit rate of an MPEG-2 stream of the same quality. Thus, to conserve bandwidth, and MPEG-4 stream can transmitted whenever all the set top terminals in a service group are MPEG-4 compliant. However, as soon as a set top terminal that only supports MPEG-2 requests that channel, the SDV manager 215 transitions the stream back to an MPEG-2 stream so that the new set top terminal will be able to tune and decode that channel.

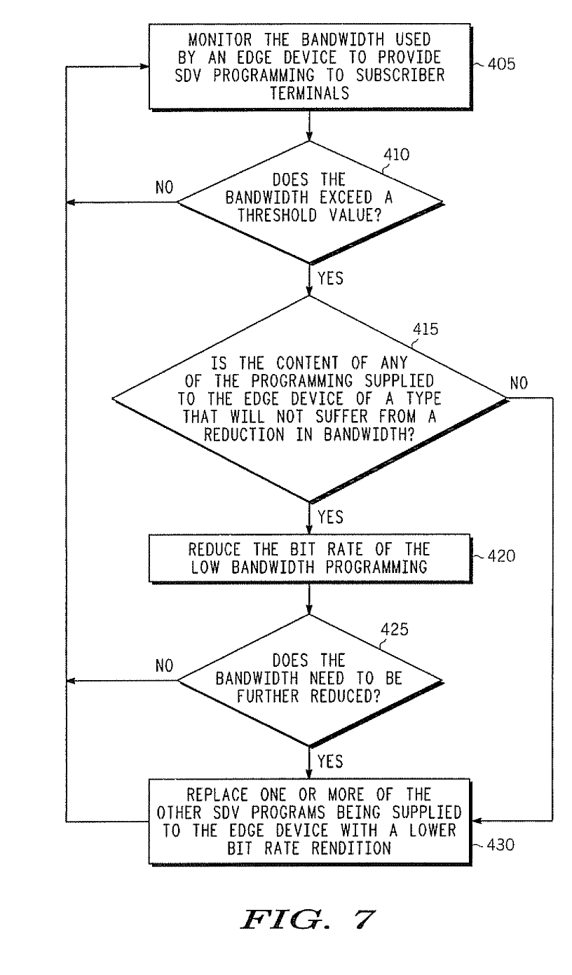

FIG. 7 is a flowchart showing one example of a method for managing bandwidth in an SDV system. The method begins in step 405 when the SDV manager or other appropriate entity monitors the bandwidth used by an edge device to provide SDV programming to subscriber terminals associated with a service group. The SDV manager may monitor the bandwidth by receiving feedback information from a rate clamp that is used to adjust the bit rate of the SDV program. At decision step 410 the SDV manager determines if the bandwidth exceeds a threshold value. If so, then at decision step 415 the SDV manager determines if the content of any of the programming supplied to edge device is of a type that will not suffer from a reduction in bandwidth, such as news programming, for example. If such programming is being supplied, its bandwidth may be reduced by the rate clamp in step 420. If, as determined at decision step 425 the bandwidth needs to be reduced still further, the SDV manager can replace one or more of the other SDV programs being supplied to the edge device with a lower bit rate rendition of it in step 430. To minimize disruption to the subscriber, the SDV manager may swap or replace a high bit rate program with a lower bit rate program (or visa versa) during a commercial or other break in programming.

The processes described above, including but not limited to those presented in connection with FIG. 7, may be implemented in general, multi-purpose or single purpose processors. Such a processor will execute instructions, either at the assembly, compiled or machine-level, to perform that process. Those instructions can be written by one of ordinary skill in the art following the description of presented above and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

1. A switched digital video (SDV) system, comprising:
a SDV manager for coordinating SDV sessions requested by subscriber terminals associated with a service group;
an input for received content to be broadcast during the SDV sessions;
at least one edge device for receiving transport streams that include SDV programming provided by the input and for transmitting each transport stream over an access network to at least one of the subscriber terminals on one of a plurality of SDV channels; and
wherein the SDV manager is configured to (i) monitor a bandwidth used by the edge device to provide the SDV programming to the service group and (ii) cause a bit rate of at least one SDV program supplied to the edge device to be adjusted based on monitored bandwidth usage.

2. The switched digital video system of claim 1 wherein the SDV manager is further configured to cause the bit rate of the SDV program to be reduced when the monitored bandwidth exceeds a first value.

3. The switched digital video system of claim 1 further comprising a rate clamp for receiving the SDV programming from the content source and providing a corresponding transport stream to the edge device, wherein the SDV manager is configured to instruct the rate clamp to adjust the bit rate of the corresponding transport stream.

4. The switched digital video system of claim 3 wherein the SDV manager receives feedback information from the rate clamp to monitor the bandwidth usage.

5. The switched digital video system of claim 1 wherein the SDV manager receives feedback information from the edge device to monitor the bandwidth usage.

6. The switched digital video of claim 3 wherein the rate clamp supplies a plurality of rate controlled transport streams that include common programming content, each of the rate controlled transport streams being clamped at a different bit rate, and further wherein the SDV manager is configured to select one of the plurality of rate controlled transport streams to be supplied to the edge device based on the monitored bandwidth usage.

7. The switched digital video system of claim 6 wherein the SDV manager is further configured to replace a selected one of the rate controlled transport streams supplied to the edge device with a lower bit rate rendition of the rate controlled transport stream when a prescribed condition arises.

8. The switched digital video system of claim 7 wherein the SDV manager replaces one transport stream with another during a commercial or other break in programming.

9. The switched digital video system of claim 1 wherein the SDV manager is configured to select an SDV program that is to be adjusted in bit rate based on a type of content included in the SDV program.

10. The switched digital video system of claim 6 wherein the SDV manager is configured to select a first of the plurality of rate controlled transport streams to a first edge device associated with a first service group and a second of the plurality of rate controlled transport streams to a second edge device associated with a second service group.

11. The switched digital video system of claim 1 wherein the edge device is a QAM modulator.

12. The switched digital video system of claim 1 wherein the SDV manager communicates with the edge device over a packet switched network.

13. The switched digital video system of claim 2 wherein the bit rate of SVD program is reduced during a commercial or other break in programming.

14. At least one computer-readable medium encoded with instructions which, when executed by a processor, performs a method including:
monitoring a bandwidth used by an edge device to provide SDV programming to subscriber terminals associated with a service group; and
causing a bit rate of at least one SDV program supplied to the edge device to be adjusted based on the monitored bandwidth usage.

15. The computer-readable medium of claim 14 further comprising causing the bit rate of the SDV program to be reduced when the monitored bandwidth exceeds a first value.

16. The computer-readable medium of claim 14 further comprising instructing a rate clamp to adjust the bit rate of the SDV program.

17. The computer-readable medium of claim 16 further comprising receiving feedback information from the rate clamp to monitor the bandwidth usage.

18. The computer-readable medium of claim 16 wherein the rate clamp supplies a plurality of rate controlled transport streams that include common programming content, each of the rate controlled transport streams being clamped at a different bit rate, and further comprising selecting one of the plurality of rate controlled transport streams to be supplied to the edge device based on the monitored bandwidth usage.

19. The computer-readable medium of claim 18 further comprising replacing the selected one of the rate controlled transport streams supplied to the edge device with a lower bit rate rendition of the rate controlled transport stream when a prescribed condition arises.

20. The computer-readable medium of claim 14 further comprising selecting the SDV program that is to be adjusted in bit rate based on a type of content included in the SDV program.
